(19) United States
(12) Patent Application Publication
(10) Pub. No.: US 2026/0371371 A1
(43) Pub. Date: Nov. 19, 2026

(54) MAPPING BETWEEN PRIMARY SYNCHRONIZATION SIGNAL (PSS) BLOCKS AND SECONDARY SYNCHRONIZATION SIGNAL (SSS) AND PHYSICAL BROADCAST CHANNEL (PBCH) BLOCKS FOR EFFICIENT MULTI-BEAM OPERATION

(71) Applicant: QUALCOMM Incorporated, San Diego, CA (US)

(72) Inventors: Hung Dinh LY, San Diego, CA (US); Jing JIANG, San Diego, CA (US); Yan ZHOU, San Diego, CA (US)

(21) Appl. No.: 19/208,186

(22) Filed: May 14, 2025

(51) Int. Cl. H04W 72/30; H04W 56/00; H04W 64/00

(52) U.S. Cl. CPC H04W 72/30; H04W 56/0015; H04W 64/003

(57) ABSTRACT

This disclosure provides methods, components, devices and systems for mapping between primary synchronization signal (PSS) blocks and secondary synchronization signal (SSS) and physical broadcast channel (PBCH) blocks for efficient multi-beam operation. For example, a user equipment (UE) may search for one or more PSS blocks of a set of candidate primary synchronization signal PSS blocks. The UE may search for one or more SSS and PBCH blocks of a set of candidate SSS and PBCH blocks based at least in part on a mapping between the one or more PSS blocks and the one or more SSS and PBCH blocks. The UE may receive the one or more SSS and PBCH blocks based at least in part on searching for the one or more PSS blocks and the one or SSS and PBCH blocks.

### TECHNICAL FIELD

This disclosure relates generally to wireless communication, and more specifically to systems, devices, methods, and techniques associated with mapping between primary synchronization signal (PSS) blocks and secondary synchronization signal (SSS) and physical broadcast channel (PBCH) blocks for efficient multi-beam operation.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include searching for one or more primary synchronization signal (PSS) blocks of a set of candidate PSS blocks, searching for one or more secondary synchronization signal (SSS) and physical broadcast channel (PBCH) blocks of a set of candidate SSS and PBCH blocks based on a mapping between the one or more PSS blocks and the one or more SSS and PBCH blocks, and receiving the one or more SSS and PBCH blocks based on searching for the one or more PSS blocks and the one or SSS and PBCH blocks.

A UE for wireless communications is described. The UE may include a processing system that includes processor circuitry and memory circuitry that stores code. The processing system may be configured to cause the UE to search for one or more PSS blocks of a set of candidate PSS blocks, search for one or more SSS and PBCH blocks of a set of candidate SSS and PBCH blocks based on a mapping between the one or more PSS blocks and the one or more SSS and PBCH blocks, and receive the one or more SSS and PBCH blocks based on searching for the one or more PSS blocks and the one or SSS and PBCH blocks.

Another UE for wireless communications is described. The UE may include means for searching for one or more PSS blocks of a set of candidate PSS blocks, means for searching for one or more SSS and PBCH blocks of a set of candidate SSS and PBCH blocks based on a mapping between the one or more PSS blocks and the one or more SSS and PBCH blocks, and means for receiving the one or more SSS and PBCH blocks based on searching for the one or more PSS blocks and the one or SSS and PBCH blocks.

A non-transitory computer-readable medium storing code for wireless communications is described. The code may include instructions executable by one or more processors to search for one or more PSS blocks of a set of candidate PSS blocks, search for one or more SSS and PBCH blocks of a set of candidate SSS and PBCH blocks based on a mapping between the one or more PSS blocks and the one or more SSS and PBCH blocks, and receive the one or more SSS and PBCH blocks based on searching for the one or more PSS blocks and the one or SSS and PBCH blocks.

Some examples of the method, UEs, and non-transitory computer-readable medium described herein may further include operations, features, means, or instructions for detecting a location of the one or more SSS and PBCH blocks based on receiving the one or more PSS blocks and the mapping indicating an association between the one or more PSS blocks and the one or more SSS and PBCH blocks, where the searching for the one or more SSS and PBCH blocks may be based on the detecting.

In some examples of the method, UEs, and non-transitory computer-readable medium described herein, each candidate PSS block of the set of candidate PSS blocks may be mapped to one or more candidate SSS and PBCH blocks of the set of candidate SSS and PBCH blocks.

In some examples of the method, UEs, and non-transitory computer-readable medium described herein, the mapping between the set of candidate PSS blocks and the set of candidate SSS and PBCH blocks indicates that each candidate PSS block of the set of candidate PSS blocks may be mapped to one or more consecutive candidate SSS and PBCH blocks.

In some examples of the method, UEs, and non-transitory computer-readable medium described herein, the mapping between the set of candidate PSS blocks and the set of candidate SSS and PBCH blocks indicates that each candidate PSS block of the set of candidate PSS blocks may be mapped to one or more non-consecutive candidate SSS and PBCH blocks according to a pattern and the pattern maps a first subset of candidate SSS and PBCH blocks to each respective candidate PSS block of the set of candidate PSS blocks and then maps a second subset of candidate SSS and PBCH blocks to each respective candidate PSS block of the set of candidate PSS blocks.

In some examples of the method, UEs, and non-transitory computer-readable medium described herein, the mapping between the set of candidate PSS blocks and the set of candidate SSS and PBCH blocks indicates that one or more index values corresponding to one or more candidate SSS and PBCH blocks of the set of candidate SSS and PBCH blocks may be incremented in ascending order in a first domain, then incremented in ascending order in a second domain.

### BRIEF DESCRIPTION OF THE DRAWINGS

FIG. 1 shows an example of a wireless communication system.

FIG. 2 shows an example of a signaling configuration that supports mapping between primary synchronization signal (PSS) blocks and secondary synchronization signal (SSS) and physical broadcast channel (PBCH) blocks for efficient multi-beam operation.

FIGS. 3A-3C show examples of mapping configurations that support mapping between PSS blocks and SSS and PBCH blocks for efficient multi-beam operation.

FIG. 4 shows an example of a mapping configuration that supports mapping between PSS blocks and SSS and PBCH blocks for efficient multi-beam operation.

FIG. 5 shows an example of a process flow that supports mapping between PSS blocks and SSS and PBCH blocks for efficient multi-beam operation.

FIG. 6 shows a block diagram of a processing system that supports mapping between PSS blocks and SSS and PBCH blocks for efficient multi-beam operation.

FIG. 7 shows a diagram of a system including a device that supports mapping between PSS blocks and SSS and PBCH blocks for efficient multi-beam operation.

FIGS. 8 and 9 show flowcharts illustrating methods that support mapping between PSS blocks and SSS and PBCH blocks for efficient multi-beam operation.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, synchronization signal (SS) and physical broadcast channel blocks (SSBs) may be used to support connection establishment and modification between a network entity and a user equipment (UE). For example, a wireless communication system may support one or more sets of SSBs within one or more slots according to a mapping configuration. The UE may search the time and/or frequency resources according to the mapping configuration to receive a set of SSBs from a network entity. The UE may establish (e.g., during initial connection establishment procedure) and modify a connection with the network entity based on the sets of SSBs. Each set of SSBs included in the mapping configuration may be associated with a respective primary synchronization signal (PSS) block and a respective secondary synchronization signal (SSS) and PBCH block. As such, the UE may search, for each set of SSBs, for a PSS block and a SSS and PBCH block associated with the set of SSBs.

However, transmitting the sets of SSBs may be associated with a relatively large quantity of time resources as each set of SSBs includes a respective PSS block as well as a SSS and PBCH block coupled in the time domain. The PSS, SSS, and PBCH may be beam swept together. Searching for the respective PSS block and the respective SSS and PBCH block for each set of SSBs may be inefficient for the UE, increasing latency and energy consumption associated with search procedures at the UE. Further, indicating to the UE which sets of SSBs are actually transmitted, and thus which time and frequency resources the UE should search for, may be associated with a relatively large signaling overhead, where a bitmap is used to signal the location (e.g., resources) of each actually transmitted SSB. Such signaling overhead may not be compatible with various signaling procedures, such as on-demand signaling (e.g., on-demand system information block type 1 (SIB1) signaling) and may be associated with increased latency and energy consumption. Therefore, enhanced signaling techniques may be desirable to reduce the signaling overhead associated with indicating actually transmitted SSBs to the UE to support search procedure for connection establishment and modification.

Accordingly, the techniques, systems, and devices described herein may support mapping between a set of candidate PSS blocks and a set of candidate SSS and PBCH blocks that are decoupled in one or more domains (e.g., the time domain, the frequency domain, or both), which may improve efficient resource utilization and may reduce signaling overhead compared to systems that utilize coupled SSB transmission. For example, a network entity may transmit one or more PSS blocks and one or more SSS and PBCH blocks decoupled in the time domain (e.g., according to time division duplexing (TDD), the frequency domain (e.g., according to FDD), or both), where the one or more PSS blocks are mapped to the one or more SSS and PBCH blocks according to one or more mapping configurations. Each candidate PSS block of the set of candidate PSS blocks is mapped to one or more candidate SSS and PBCH blocks of the set of candidate SSS and PBCH blocks such that a quantity of time resources (e.g., slots) used to transmit the one or more PSS blocks and the one or more SSS and PBCH blocks is reduced compared to transmitting a corresponding set of SSBs, which may support network energy savings. Additionally, the UE may search for the one or more SSS and PBCH blocks based on receiving the one or more PSS blocks, where the mapping may indicate which SSS and PBCH blocks of the set of candidate SSS and PBCH blocks area actually transmitted based on which PSS blocks of the candidate PSS blocks are detected by the UE. As such, signaling overhead associated with indicating to the UE which signals are actually transmitted may be reduced compared to systems that implement decoupled SSB transmission.

Particular aspects of the subject matter described in this disclosure can be implemented to realize one or more of the following potential advantages. In some examples, by decoupling the set of candidate PSS blocks from the set of candidate SSS and PBCH blocks in one or more domains, a quantity of resources required to transmit the set of candidate PSS blocks and the set of candidate SSS and PBCH blocks may be reduced compared to systems that utilize coupled SSB transmission. Decoupled PSS block and SSS and PBCH block transmission may therefore provide opportunities for the network entity to enter an energy saving mode, resulting in increased energy saving gains. Additionally, the mapping between the PSS blocks and the SSS and PBCH blocks may enable the UE to search for SSS and PBCH blocks that are actually transmitted, based at least in part on having detected the corresponding PSS blocks. As such, the UE may refrain from searching for all of the candidate SSS and PBCH blocks included in the set of candidate SSS and PBCH blocks, as the UE may determine or detect which SSS and PBCH blocks of the set of candidate SSS and PBCH blocks are actually transmitted, as indicated by which PSS blocks of the set of candidate PSS blocks are received by the UE. Thus, the UE may perform multi-beam operation operations with increased efficiency and reduced energy consumption.

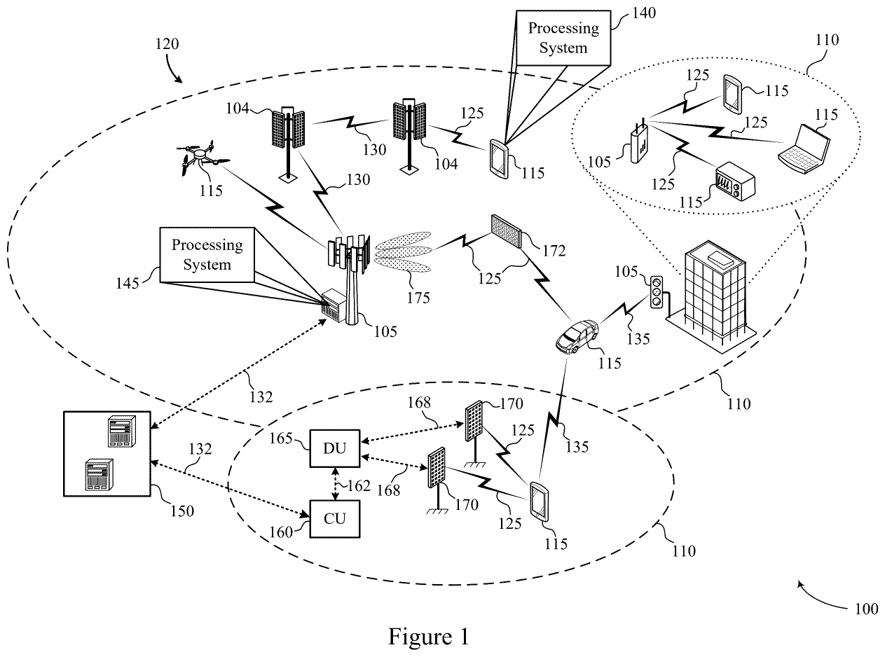

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for mapping between PSS blocks and SSS and PBCH blocks for efficient multi-beam operation. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support mapping between PSS blocks and SSS and PBCH blocks for efficient multi-beam operation for network energy savings.

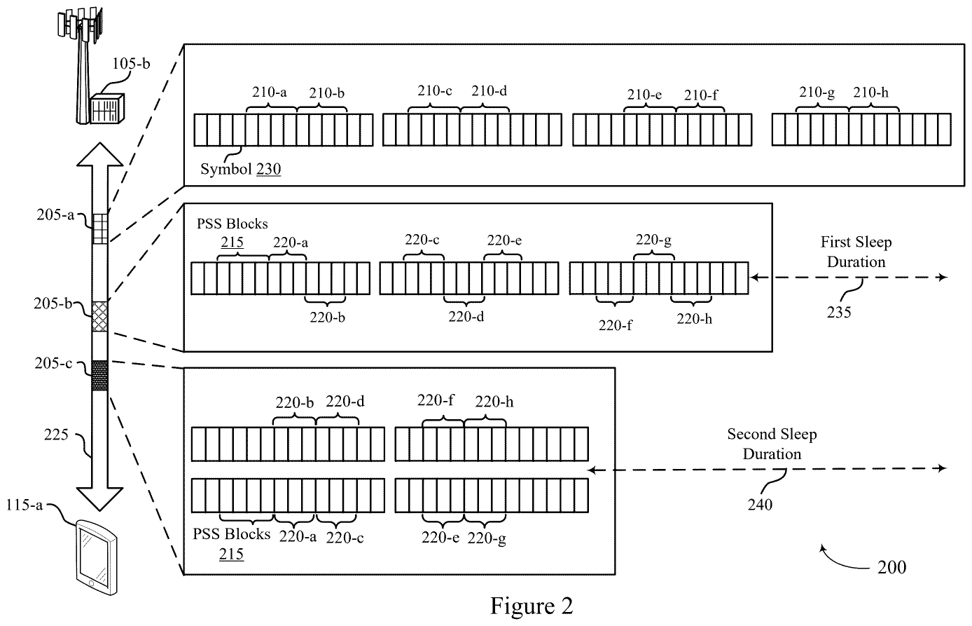

FIG. 2 shows an example of a signaling diagram 200 that supports mapping between PSS blocks and SSS and PBCH blocks for efficient multi-beam operation in accordance with aspects of the present disclosure. The signaling diagram 200 may implement or be implemented by aspects of the wireless communication system 100 as described herein with reference to FIG. 1. For example, the signaling diagram 200 may be implemented by a network entity 105-a and a UE 115-a, which may represent examples of a network entity 105 and a UE 115, or some other devices, as described herein with reference to FIG. 1. The network entity 105-a and the UE 115-a may communicate via a communication link 225. In this example, the UE 115-a may perform various multi-beam based procedures in accordance with a mapping configuration 205.

In some wireless communication systems, SSBs may be used to support connection establishment/modification between the network entity 105-a and the UE 115-a. For example, the wireless communication system may support one or more SSBs 210 within one or more slots according to a mapping configuration 205-a. The mapping configuration 205-a illustrates a slot pattern having 14 symbols 230, although each slot of the 4 slots included in the mapping configuration 205-a is not limited to 14 symbols 230. The mapping configuration 205-a includes a first SSB 210-a (e.g., SSB0) spanning a corresponding first set of symbols of a first slot, a second SSB 210-b (e.g., SSB1) spanning a corresponding second set of symbols of the first slot, a third SSB 210-c (e.g., SSB2) spanning a corresponding third set of symbols of a second slot, a fourth SSB 210-d (e.g., SSB3) spanning a corresponding fourth set of symbols of the second slot, a fifth SSB 210-e (e.g., SSB4) spanning a corresponding fifth set of symbols of a third slot, a sixth SSB 210-f (e.g., SSB5) spanning a corresponding sixth set of symbols of the third slot, a seventh SSB 210-g (e.g., SSB6) spanning a corresponding seventh set of symbols of a fourth slot, and an eighth SSB 210-h spanning a corresponding eighth set of symbols of the fourth slot. The UE 115-a may search the resources of a time and/or frequency band according to the mapping configuration 205-a to receive one or more of the SSBs 210 from the network entity 105-a. The UE 115-a may establish (e.g., during initial connection establishment procedure) and/or modify a connection with the network entity 105-a based on the SSBs 210. Each SSB 210 included in the mapping configuration 205-a may be associated with a respective PSS block and a respective SSS and PBCH block. As such, the UE 115-a may receive, via each SSB 210, a PSS block and a SSS and PBCH block associated with the SSB 210.

However, transmitting the SSBs 210 may utilize a relatively large quantity of time resources (e.g., may span a relatively large quantity of slots). Additionally, searching for a respective PSS block and a respective SSS and PBCH block associated with each corresponding SSB 210 may be inefficient for the UE 115-a . Further, indicating to the UE 115-a which SSBs 210 are actually transmitted, and thus which time and frequency resources the UE 115-a should search for, may result in a relatively large signaling overhead. In some cases, on-demand signaling (e.g., on-demand system information block type 1 (SIB1) signaling) may be infeasible (e.g., for systems that implement 5G standalone cells) due to the signaling overhead associated with indicating the actually transmitted SSBs. For example, during an on-demand signaling procedure (e.g., on-demand SIB1 procedure), the UE 115-a may receive an on-demand signaling procedure configuration (e.g., on-demand-SIB1 procedure configuration) that may indicate one or more parameters for performing the on-demand signaling procedure. In some cases the UE 115-a may receive one or more SSBs 210 (e.g., from a network energy saving cell). The UE 115-a may transmit an on-demand signaling request (e.g., a physical random access channel (PRACH), a wakeup signal (WUS)) that requests an on-demand signal (e.g., SIB1). The UE 115-a may receive a random access response (RAR) followed by the requested on-demand signal. As such, the UE 115-a may use an indication of actually transmitted SSBs to determine resources for transmitting the on-demand signaling request as well as resources for monitoring and receiving a subsequent downlink transmission (e.g., PDCCH, PDSCH). However, transmitting the indication of actually transmitted SSBs (e.g., via a master information block (MIB)) may utilize a relatively large amount of bits (e.g., up to 64 bits, a full bitmap, up to 16 bits, a group bitmap), which may be associated with increased latency and energy consumption. Therefore, techniques described herein may reduce the signaling overhead associated with indicating actually transmitted SSBs to the UE 115-a in order to support on-demand signaling procedures.

Accordingly, the techniques, systems, and devices described herein may support mapping between PSS blocks and SSS and PBCH blocks that are decoupled in one or more domains, which may improve resource utilization and reduce signaling overhead compared to systems that utilize coupled SSB transmission. For example, as enabled by the techniques described herein, the network entity 105-a may transmit one or more PSS blocks and one or more SSS and PBCH blocks decoupled in the time domain (e.g., according to TDD), the frequency domain (e.g., according to FDD), or both, where the one or more PSS blocks are mapped to the one or more SSS and PBCH blocks according to one or more mapping configurations, such as the mapping configuration 205-b and the mapping configuration 205-c. Each candidate PSS block of a set of candidate PSS blocks 215 is mapped to one or more candidate SSS and PBCH blocks of a set of candidate SSS and PBCH blocks (e.g., one PSS block may correspond to 8 SSS and PBCH blocks in FR1, 12 PSS blocks may correspond to 64 SSS and PBCH blocks, etc.). As such, compared to coupled SSB transmission, the set of candidate PSS blocks 215 and the set of candidate SSS and PBCH blocks may span a fewer quantity of time resources (e.g., slots), which may support network energy savings. Additionally, the UE 115-a may search for one or more SSS and PBCH blocks based on receiving one or more corresponding PSS blocks mapped to the one or more SSS and PBCH blocks. In other words, the UE 115-a may determine which SSS and PBCH blocks of the set of candidate SSS and PBCH blocks are actually transmitted based on which PSS blocks are searched/received by the UE 115-a. As such, signaling overhead associated with indicating to the UE 115-a which signals are actually transmitted may be reduced compared to other systems that do not use decoupled SSB transmission.

For example, as shown by the mapping configuration 205-b, the set of candidate PSS blocks 215 may be mapped to span a corresponding first set of symbols of a first slot. The set of candidate PSS blocks 215 may include one or more PSS blocks, where each PSS block may span one or more (e.g., a single, multiple) symbols of the first slot. As described in the context of the mapping configuration 205-a (e.g., which is not meant to be a limiting example), the set of candidate PSS blocks 215 includes 4 PSS blocks, each of which span a symbol of the first slot, such that the first set of symbols includes symbols {3, 4, 5, 6} of a first slot. The set of candidate SSS and PBCH blocks may be mapped to span a corresponding second set of symbols of one or more second slots, such that the set of candidate SSS and PBCH blocks are decoupled from the set of candidate PSS blocks 215 in the time domain. For example, the set of candidate SSS and PBCH blocks may include 8 candidate SSS and PBCH blocks 220 (e.g., SSS/PBCH0-SSS/PBCH7) that each span 3 symbols 230 within the one or more second slots. Each candidate SSS and PBCH block 220 may correspond to a SSS and PBCH block included in a corresponding set of SSBs (e.g., SSS/PBCH0 may correspond to SSB0, SSS/PBCH1 may correspond to SSB1, etc.).

Decoupling the PSS blocks and the SSS and PBCH blocks may enable the UE 115-a to perform fewer searches when performing a connection establishment/modification procedure. According to the mapping configuration 205-b, the UE 115-a may perform 4 searches for the set of candidate PSS blocks 215 (e.g., one search per candidate PSS block included in the set of candidate PSS blocks 215) and up to 8 searches of the set of candidate SSS and PBCH blocks. Thus the UE 115-a may perform fewer searches when the set of candidate PSS blocks 215 is decoupled from the set of candidate SSS and PBCH blocks, compared to searching corresponding coupled SSBs. Additionally, in some cases (e.g., for FR1), the UE 115-a may be capable of searching SSS and PBCH blocks without searching the set of candidate PSS blocks 215 (e.g., single frequency network (SFN) gain may improve PSS block detection) further increasing search efficiency at the UE 115-a. The set of candidate PSS blocks 215 and the set of candidate SSS and PBCH blocks may span a fewer quantity of slots than the SSBs 210, as shown by mapping configurations 205-b and 205-c respectively, which may support network energy savings. For example, the network entity 105-a may power off for a first sleep duration 235 after transmitting the one or more PSS blocks of the set of candidate PSS blocks 215 and one or more SSS and PBCH blocks of the set of candidate SSS and PBCH blocks. By reducing the quantity of time resources spanned by the set of candidate PSS blocks 215 and the set of candidate SSS and PBCH blocks, the mapping configuration 205-b provides opportunities for network energy savings (e.g., such as the first sleep duration 235) compared to the mapping configuration 205-a.

In some cases, the mapping between the set of candidate PSS blocks 215 and the set of candidate SSS and PBCH blocks indicates that each candidate PSS block of the set of candidate PSS blocks 215 is mapped to one or more (e.g., consecutive) candidate SSS and PBCH blocks in the time domain. For example, as shown by the mapping configuration 205-b, the first candidate PSS block of the set of candidate PSS blocks 215 may be mapped to the first candidate SSS and PBCH block 220-a and the second candidate SSS and PBCH block 220-b, which may span symbols {7, 8, 9} and {10, 11, 12} of the first slot. In other cases, the mapping between the set of candidate PSS blocks 215 and the set of candidate SSS and PBCH blocks indicates that each candidate PSS block of the set of candidate PSS blocks 215 is mapped to one or more non-consecutive candidate SSS and PBCH blocks according to a pattern, where the pattern maps a first subset of candidate SSS and PBCH blocks 220 to each respective candidate PSS block of the set of candidate PSS blocks 215, and then maps a second subset of candidate SSS and PBCH blocks 220 to each respective candidate PSS block of the set of candidate PSS blocks 215. For example, the first candidate PSS block of the set of candidate PSS blocks 215 may be mapped to the first the first candidate SSS and PBCH block 220-a, the second candidate PSS block of the set of candidate PSS blocks 215 may be mapped to the second candidate SSS and PBCH block 220-b, the third candidate PSS block of the set of candidate PSS blocks 215 may be mapped to the third candidate SSS and PBCH block 220-c, and the fourth candidate PSS block of the set of candidate PSS blocks 215 may be mapped to the fourth candidate SSS and PBCH block 230-d. The pattern of the mapping may repeat, such that each candidate PSS block of the set of candidate PSS blocks 215 may be mapped to remaining candidate SSS and PBCH blocks 220 of the set of candidate SSS and PBCH blocks (e.g., in an alternating fashion). Thus, in some cases, each candidate PSS block of the set of candidate PSS blocks 215 may be mapped to one or more consecutive candidate SSS and PBCH blocks of the set of candidate SSS and PBCH blocks, or one or more non-consecutive candidate SSS and PBCH blocks of the set of candidate SSS and PBCH blocks. Additionally, in some cases, the UE 115-a may assume that an SSS block and a PBCH block included within a respective candidate SSS and PBCH block are transmitted over the same antenna port(s). In some examples, an antenna port used to transmit a respective candidate PSS block may be different than the antenna port(s) used to transmit the respective candidate SSS and PBCH block, and the UE 115-a may refrain form assuming that the same antenna port(s) are used to transmit a candidate PSS block and one or more corresponding candidate SSS and PBCH blocks 220.

To further increase network energy savings, the set of candidate PSS blocks 215 and the set of candidate SSS and PBCH blocks may be decoupled in both the time domain and the frequency domain as shown by the mapping configuration 205-c. For example, as shown by the mapping configuration 205-c, the set of candidate PSS blocks 215 are mapped to a first set of symbols in a first slot and the set of candidate SSS and PBCH blocks are mapped to a second set of symbols in one or more second slots, where the first slot and the one or more second slots are included within a set of frequency bands. In some cases, one or more candidate SSS and PBCH blocks 220 may be located in common symbols of a slot within separate frequency bands. For example, both the first candidate SSS and PBCH block 220-a (e.g., SSS/PBCH 0) and the second candidate SSS and PBCH block 220-b (e.g., SSS/PBCH 1) are located in symbols {7, 8, 9} of the first slot within a first frequency band and a second frequency band, respectively. The remaining candidate SSS and PBCH blocks 220 of the set of candidate SSS and PBCH blocks may be mapped in a similar time and frequency pattern as the first candidate SSS and PBCH block 220-a and the second candidate SSS and PBCH block 220-b. For example, according to the time and frequency pattern, a fifth candidate SSS and PBCH block 220-e (e.g., SSS/PBCH 4) and a sixth candidate SSS and PBCH block 220-f (e.g., SSS/PBCH 5) are located within in symbols {3, 4, 5} of a second slot of the first frequency band and the second frequency band, respectively.

Accordingly, a total quantity of symbols 230 associated spanned by the mapping of the set of candidate PSS blocks 215 and the set of candidate SSS and PBCH blocks is reduced compared to the mapping configuration 205-b, and even further reduced compared to the mapping configuration 205-a, which may result in increased network energy savings. For example, the network entity 105-a may enter the network energy saving mode after transmitting the set of candidate PSS blocks 215 and the set of SSS and PBCH blocks for a second sleep duration 240, which may be longer than the first sleep duration 235 associated with the mapping configuration 205-b.

Similar to the mapping configuration 205-b, the UE 115-a may perform fewer searches of the set of candidate PSS blocks 215 than the set of candidate SSS and PBCH blocks, as each candidate PSS block may correspond to one or more candidate SSS and PBCH blocks 220. For example, the UE 115-a may perform at most 4 searches of the set of candidate PSS blocks 215 (e.g., one search per candidate PSS block included in the set of candidate PSS blocks 215) and up to one search per candidate SSS and PBCH block 220 included in the set of candidate SSS and PBCH blocks, equaling a total of at most 12 searches. Similar to the mapping configuration 205-b, decoupling the set of candidate PSS blocks 215 and the set of candidate SSS and PBCH blocks may improve search efficiency at the UE 115-a compared to systems that implement coupled SSB transmission, such as according to the mapping configuration 205-a. Further, due to the mapping between the set of candidate PSS blocks 215 and the set of candidate SSS and PBCH blocks, the UE 115-a may determine which SSS and PBCH blocks of the set of candidate SSS and PBCH blocks are actually transmitted based on which PSS blocks of the set of candidate PSS blocks 215 the UE 115-a detects while searching. For example, according to the mapping configuration 205-c, a fourth PSS block of the set of candidate PSS blocks 215 may be mapped to both a seventh candidate SSS and PBCH block 220-g and an eighth candidate SSS and PBCH block 220-h. If the UE 115-a detects the fourth candidate PSS block, the UE 115-a will search for the seventh candidate SSS and PBCH block 220-g and the eighth candidate SSS and PBCH block 220-h based on the mapping. Therefore, the UE 115-a may refrain from searching for SSS and PBCH blocks that are not actually transmitted without a direct indication (e.g., bitmap) of which SSS and PBCH blocks are actually transmitted, which may reduce signaling overhead at the network entity 105-a. That is, the UE 115-a may only search for SSS and PBCH blocks corresponding to received PSSs. If a given PSS is not received, then the UE 115-a may refrain from searching for corresponding SSS/PBCH blocks.

In some cases, the one or more first symbols in which the one or more PSS blocks are transmitted and the one or more second symbols in which the one or more SSS and PBCH blocks are transmitted are included in a common slot based at least in part on a quantity of the one or more second symbols satisfying a threshold quantity. For example, the one or more SSS and PBCH blocks may be transmitted by the network entity 105-b in the same (e.g., a common) slot as the one or more PSS blocks if there are enough symbols in the slot to accommodate both the one or more PSS blocks and the one or more SSS and PBCH blocks. Whether the one or more PSS blocks and the one or more SSS and PBCH blocks are transmitted in the same slot may be associated with a mapping ratio (e.g., K) between the one or more PSS blocks and the one or more SSS and PBCH blocks. In some cases, the mapping ratio may accommodate transmission of the one or more PSS blocks and the one or more SSS and PBCH blocks in the same slot (e.g., K=2). In other cases (e.g., for FR2 where 16 PSS blocks are mapped to 48 SSS and PBCH blocks), the one or more PSS blocks may be transmitted in one or more first slots, while the one or more SSS and PBCH blocks may be transmitted in one or more second slots.

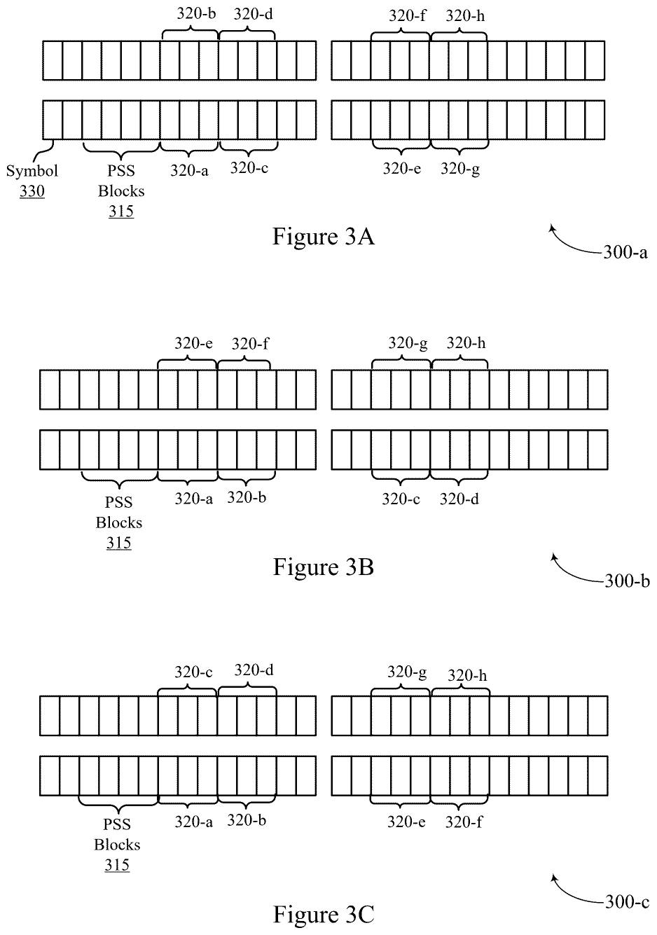

The mapping between the set of candidate PSS blocks 215 and the set of candidate SSS and PBCH blocks may be configured in various ways not limited to the examples provided by the mapping configuration 205-b and the mapping configuration 205-c. For example, the candidate PSS blocks of the set of candidate PSS blocks 215 may be mapped to any number of candidate SSS and PBCH blocks 220 of the set of candidate SSS and PBCH blocks, and may span one or more symbols. As such, the mapping configuration 205-b and the mapping configuration 205-c are non-limiting examples of mapping configurations supported by the techniques described herein. Various mapping configurations between PSS blocks and SSS and PBCH blocks are further described with reference to FIGS. 3A-3C.

FIGS. 3A-3C show examples of mapping configurations 300-a, 300-b , and 300-c that support mapping between PSS blocks and SSS and PBCH blocks for efficient multi-beam operation according to the techniques described herein. In some cases, the mapping configurations 300-a, 300-b, and 300-c may be implemented by or may otherwise implement aspects of the wireless communication system 100 or the signaling diagram 200. For example, one or more UEs 115, one or more network entities 105, or both may communicate according to the mapping configurations 300-a, 300-b, and 300-c.

The UE 115-a may be configured with PSS blocks 315 and SSS/PBCH blocks 320. However, if the UE is not aware of a mapping between PSSs and SSS/PBCH blocks, then the UE may not successfully perform or report SSB measurements. The UE may receive control signaling indicating a mapping between PSSs and SSS and PBCH blocks, or may determine ethe mapping according to one or more rules, as described with reference to FIGS. 3A, 3B, and 3C.

FIG. 3A shows a mapping configuration 300-a that maps a set of candidate PSS blocks 315 to a set of candidate SSS and PBCH blocks, where the set of candidate PSS blocks 315 and the set of candidate SSS and PBCH blocks 320 are decoupled in the time domain and the frequency domain. For example, in some cases (e.g., when a wider channel bandwidth is supported) a plurality of candidate SSS and PBCH blocks 320 included in the set of candidate SSS and PBCH blocks may be both frequency division multiplexed and time division multiplexed, where one or more index values corresponding to the one or more candidate SSS and PBCH blocks 320 are incremented in ascending order in the frequency domain then incremented in ascending order in the time domain. Additionally, the candidate PSS blocks of the set of candidate PSS blocks 315 may be time division multiplexed (e.g., but not frequency division multiplexed), which may facilitate low detection complexity for the PSS blocks included in the set of candidate PSS blocks 315 (e.g., using sparse sync raster).

As shown in FIG. 3A, the set of candidate PSS blocks 315 may span a first set of symbols and the set of candidate SSS and PBCH blocks may span a second set of symbols within two (e.g., or more) frequency bands. Each candidate PSS block of the set of candidate PSS blocks 315 may be mapped to one or more candidate SSS and PBCH blocks 320 of the set of candidate SSS and PBCH blocks. In some cases, as shown in FIG. 3A, the mapping between the set of candidate PSS blocks 315 and the set of candidate SSS and PBCH blocks indicates that one or more index values corresponding to one or more candidate SSS and PBCH blocks of the set of candidate SSS and PBCH blocks are incremented in ascending order in a first domain (e.g., the frequency domain), then incremented in ascending order in a second domain (e.g., the time domain). For example, the set of candidate PSS blocks 315 span symbols {3, 4, 5, 6} within a first frequency band. A first candidate PSS block of the set of candidate PSS blocks (e.g., PSS block in symbol 3 of the first slot) is mapped to a first candidate SSS and PBCH block 320-a (e.g., SSS/PBCH0) and a second candidate SSS and PBCH block 320-b (e.g., SSS/PBCH1). A first index value associated with the first candidate SSS and PBCH block 320-a and a second index value associated with the second candidate SSS and PBCH block 320-b are incremented in ascending order such that the first candidate SSS and PBCH block 320-a is mapped to symbols {7, 8, 9} of the first slot in the first frequency band, and the second candidate SSS and PBCH block 320-b is mapped to symbols {7, 8, 9} of the first slot in the second frequency band.

Index values corresponding to remaining candidate SSS and PBCH blocks 320 of the set of candidate SSS and PBCH blocks are further incremented in ascending order in the frequency domain then the time domain. For example, a second candidate PSS block (e.g., PSS block in symbol 4 of the first slot) is mapped to a third candidate SSS and PBCH block 320-c and a fourth candidate SSS and PBCH block 320-d. A third index value associated with the third candidate SSS and PBCH block 320-c and a fourth index value associated with the fourth candidate SSS and PBCH block 320-d are incremented in ascending order such that the third candidate SSS and PBCH block 320-c is mapped to symbols {10, 11, 12} of the first slot in the first frequency band, and the fourth candidate SSS and PBCH block 320-d is mapped to symbols {10, 11, 12} of the first slot in the second frequency band. Similar mapping maps a third candidate PSS block of the set of candidate PSS blocks 315 to a fifth candidate SSS and PBCH block 320-e and a sixth candidate SSS and PBCH block 320-f, and maps a fourth candidate PSS block of the set of candidate PSS blocks 315 to a seventh candidate SSS and PBCH block 320-g and an eighth candidate SSS and PBCH block 320-h. The index values of the candidate SSS and PBCH blocks 320 are incremented in ascending order in the frequency domain and then in the time domain such that each candidate PSS block of the set of candidate PSS blocks 315 is mapped to a candidate SSS and PBCH block 320 in the first frequency band and a candidate SSS and PBCH block in the second frequency band, as shown by the mapping configuration 300-a.

Thus, as described with reference to FIG. 3A, SSS and PBCH blocks 320 may increment first in the frequency domain (e.g., the SSS and PBCH block 320-a, followed by the SSS and PBCH block 320-b) and then in the time domain (e.g., the SSS and PBCH block 320-c followed by the SSS and PBCH block 320-c). Based on the mapping (e.g., which may be determined by the UE 115-a or may be indicated via control signaling, or both), the UE may determine that a first PSS of the PSS block 315 maps to the SSS and PBCH block 320-a and the SSS and PBCH block 320-b, a second PSS block 315 maps to the SSS and PBCH block 320-c and the SSS PBCH block 320-d, etc.

Accordingly, a UE may detect one of the candidate PSS blocks included in the set of candidate PSS blocks 315 and may determine a location (e.g., a slot location) of one or more SSS and PBCH blocks based on the mapping between the set of candidate PSS blocks 315 and the set of candidate SSS and PBCH blocks. For example, if the UE detects the second candidate PSS block and the third candidate PSS block, the UE may monitor for the third candidate SSS and PBCH block 320-c and the fourth candidate SSS and PBCH block 320-d within the symbols {10, 11, 12} of the first slot in the first frequency band and the second frequency band, respectively, and may monitor for the fifth candidate SSS and PBCH block 320-e and the sixth candidate SSS and PBCH block 320-f within symbols {3, 4, 5} of the second slot in the first frequency band and the second frequency band, respectively. As such, the mapping configuration 300-a indicates the location of actually transmitted SSS and PBCH blocks to the UE 115-a, based on which candidate PSS blocks of the set of candidate PSS blocks 315 are detected (e.g., received) by the UE 115-a.

FIG. 3B shows a mapping configuration 300-b that maps the set of candidate PSS blocks 315 to the set of candidate SSS and PBCH blocks, where the set of candidate PSS blocks 315 and the set of candidate SSS and PBCH blocks are decoupled in the time domain and the frequency domain. For example, in some cases (e.g., when a wider channel bandwidth is supported) a plurality of candidate SSS and PBCH blocks 320 included in the set of candidate SSS and PBCH blocks may be both frequency division multiplexed and time division multiplexed, where one or more index values corresponding to the one or more candidate SSS and PBCH blocks are incremented in ascending order in the time domain then incremented in ascending order in the frequency domain. Additionally, the candidate PSS blocks of the set of candidate PSS blocks 315 may be time division multiplexed (e.g., but not frequency division multiplexed), which may facilitate low detection complexity for the PSS blocks included in the set of candidate PSS blocks 315 (e.g., using sparse sync raster).

As shown in FIG. 3B, the set of candidate PSS blocks 315 may span a first set of symbols, while the set of candidate SSS and PBCH blocks may span a second set of symbols within two (e.g., or more) frequency bands. Each candidate PSS block of the set of candidate PSS blocks 315 may be mapped to one or more candidate SSS and PBCH blocks 320 of the set of candidate SSS and PBCH blocks. In some cases, as shown in FIG. 3B, one or more index values corresponding to one or more candidate SSS and PBCH blocks 320 of the set of candidate SSS and PBCH blocks are incremented in ascending order in the time domain, and then incremented in ascending order in the frequency domain. For example, the set of candidate PSS blocks 315 span symbols {3, 4, 5, 6} within a first frequency band. A first candidate PSS block of the set of candidate PSS blocks (e.g., a PSS block in symbol 3 of the first slot) is mapped to the first candidate SSS and PBCH block 320-a (e.g., SSS/PBCH0) and the second candidate SSS and PBCH block 320-b (e.g., SSS/PBCH1). The first index value associated with the first candidate SSS and PBCH block 320-a (e.g., SSS/PBCH0) and the second index value associated with the second candidate SSS and PBCH block 320-b (e.g., SSS/PBCH1) are incremented in ascending order such that the first candidate SSS and PBCH block 320-a is mapped to symbols {7, 8, 9} of the first slot in the first frequency band, and the second candidate SSS and PBCH block 320-b is mapped to symbols {10, 11, 12} of the first slot in the first frequency band.

Index values corresponding to remaining candidate SSS and PBCH blocks 320 of the set of candidate SSS and PBCH blocks are further incremented in ascending order in the frequency domain then the time domain. For example, a second candidate PSS block (e.g., a PSS block in symbol 4 of the first slot) is mapped to the third candidate SSS and PBCH block 320-c (e.g., SSS/PBCH2) and the fourth candidate SSS and PBCH block 320-d (e.g., SSS/PBCH3). A third index value associated with the third candidate SSS and PBCH block 320-c and a fourth index value associated with the fourth candidate SSS and PBCH block 320-d are incremented in ascending order such that the third candidate SSS and PBCH block 320-c is mapped to symbols {3, 4, 5} of a second slot in the first frequency band, and the fourth candidate SSS and PBCH block 320-d is mapped to symbols {6, 7, 8} of the second slot in the first frequency band. Similar mapping maps the third candidate PSS block of the set of candidate PSS blocks 315 to the fifth candidate SSS and PBCH block 320-e (e.g., SSB/PBCH4) and the sixth candidate SSS and PBCH block 320-f (e.g., SSB/PBCH5), and maps the fourth candidate PSS block of the set of candidate PSS blocks 315 to the seventh candidate SSS and PBCH block 320-g (e.g., SSB/PBCH6) and the eighth candidate SSS and PBCH block 320-h (e.g., SSB/PBCH7). For example, the fifth candidate SSS and PBCH block 320-e is mapped to symbols {7, 8, 9} of the first slot in the second frequency band, and the sixth candidate SSS and PBCH block 320-f is mapped to symbols {10, 11, 12} of the first slot in the second frequency band. The seventh candidate SSS and PBCH block 320-g is mapped to symbols {3, 4, 5} of the second slot in the second frequency band, and the eighth candidate SSS and PBCH block 320-h is mapped to the symbols {6, 7, 8} of the second slot in the second frequency band.

Thus, according to the mapping (e.g., which the UE 115-a may determine, or which may be indicated via control signaling, or a combination thereof), the PSSs of the PSS block 315 may map to one or more SSS and PBCH blocks 320 in ascending order in the time domain first, and then the frequency domain (e.g., in each slot). For instance, a first PSS may map to the SSS and PBCH block 320-a and the SSS and PBCH block 320-b (e.g., in the same band and the same slot), and a second PSS may map to the SSS and PBCH block 320-c and the SSS PBCH block 320-d (e., in the same band and in a second slot). Subsequent PSSs may map to SSS and PBCH blocks 320 in a second band over the first slot and the second slot in increasing order of index value.

Accordingly, a UE may detect one or more PSS blocks included in the set of candidate PSS blocks 315 and may determine a location (e.g., a slot location) of one or more SSS and PBCH blocks based on the mapping between the set of candidate PSS blocks 315 and the set of candidate SSS and PBCH blocks. For example, if the UE detects the first candidate PSS block, the UE may monitor for the first candidate SSS and PBCH block 320-a and the second candidate SSS and PBCH block 320-b within the symbols {7, 8, 9, 10, 11, 12} of the first slot in the first frequency band. As such, the mapping configuration 300-a indicates the location of actually transmitted SSS and PBCH blocks to the UE 115-a, based on which candidate PSS blocks of the set of candidate PSS blocks 315 are detected (e.g., received) by the UE 115-a.

FIG. 3C shows a mapping configuration 300-c that maps the set of candidate PSS blocks 315 to the set of candidate SSS and PBCH blocks, where the set of candidate PSS blocks 315 and the set of candidate SSS and PBCH blocks are decoupled in the time domain and the frequency domain. For example, in some cases (e.g., when a wider channel bandwidth is supported) a plurality of candidate SSS and PBCH blocks 320 included in the set of candidate SSS and PBCH blocks may be both frequency division multiplexed and time division multiplexed, where one or more index values corresponding to the one or more candidate SSS and PBCH blocks 320 are incremented in ascending order in the time domain then incremented in ascending order in the frequency domain in one or more time intervals (e.g., within one or more slots). Additionally, the candidate PSS blocks of the set of candidate PSS blocks 315 may be time division multiplexed (e.g., but not frequency division multiplexed), which may facilitate low detection complexity for the PSS blocks included in the set of candidate PSS blocks 315 (e.g., using sparse sync raster).

As shown in FIG. 3C, the set of candidate PSS blocks 315 may span a first set of symbols, while the set of candidate SSS and PBCH blocks may span a second set of symbols within two (e.g., or more) frequency bands. Each candidate PSS block of the set of candidate PSS blocks 315 may be mapped to one or more candidate SSS and PBCH blocks 320 of the set of candidate SSS and PBCH blocks. In some cases, as shown in FIG. 3C, within a first time interval (e.g., a first slot), one or more index values corresponding to one or more candidate SSS and PBCH blocks 320 of the set of candidate SSS and PBCH blocks are incremented in ascending order in the time domain, then incremented in ascending order in the frequency domain. One or more index values corresponding one or more remaining candidate SSS and PBCH blocks 320 of the set of candidate SSS and PBCHs blocks are then incremented in ascending order in the time domain, then incremented in ascending order in the frequency domain in a second time interval (e.g., a second slot).

For example, the first candidate PSS block of the set of candidate PSS blocks 315 (e.g., a PSS block in symbol 3 of the first slot) is mapped to the first candidate SSS and PBCH block 320-a (e.g., SSS/PBCH0) and the second candidate SSS and PBCH block 320-b (e.g., SSS/PBCH1). The first index value associated with the first candidate SSS and PBCH block 320-a and the second index value associated with the second candidate SSS and PBCH block 320-b are incremented in ascending order in the time domain such that the first candidate SSS and PBCH block 320-a is mapped to symbols {7, 8, 9} of the first slot in the first frequency band, and the second candidate SSS and PBCH block 320-b is mapped to symbols {10, 11, 12} of the first slot in the first frequency band. The second candidate PSS block (e.g., PSS block in symbol 4 of the first slot) is mapped to the third candidate SSS and PBCH block 320-c (e.g., SSS/PBCH2) and the fourth candidate SSS and PBCH block 320-d (e.g., SSS/PBCH3). The third index value associated with the third candidate SSS and PBCH block 320-c and the fourth index value associated with the fourth candidate SSS and PBCH block 320-d are incremented in ascending order in the time domain such that the third candidate SSS and PBCH block 320-c is mapped to symbols {7, 8, 9} of the first slot in a second frequency band, and the fourth candidate SSS and PBCH block 320-d is mapped to symbols {10, 11, 12} of the first slot in the second frequency band. Similar mapping maps the third candidate PSS block of the set of candidate PSS blocks 315 to the fifth candidate SSS and PBCH block 320-e (e.g., SSB/PBCH4) and the sixth candidate SSS and PBCH block 320-f (e.g., SSB/PBCH5), and maps the fourth candidate PSS block of the set of candidate PSS blocks 315 to the seventh candidate SSS and PBCH block 320-g (e.g., SSB/PBCH6) and the eighth candidate SSS and PBCH block 320-h (e.g., SSB/PBCH7). For example, the fifth candidate SSS and PBCH block 320-e is mapped to symbols {3, 4, 5} of the second slot in the first frequency band, and the sixth candidate SSS and PBCH block 320-f is mapped to symbols {6, 7, 8} of the second slot in the first frequency band. The seventh candidate SSS and PBCH block 320-g is mapped to symbols {3, 4, 5} of the second slot in the second frequency band, and the eighth candidate SSS and PBCH block 320-h is mapped to symbols {6, 7, 8} of the second slot in the second frequency band.

Thus, the SSS and PBCH blocks 320 may be mapped in increasing order of index value first in the time domain and then in the frequency domain within a given slot, and then may continue to be mapped in increasing order of index value in the time domain and then in the frequency domain in a second slot.

Accordingly, a UE may detect one of the candidate PSS blocks included in the set of candidate PSS blocks 315 and may determine a location (e.g., a slot location) of one or more SSS and PBCH blocks based on the mapping between the set of candidate PSS blocks 315 and the set of candidate SSS and PBCH blocks. For example, if the UE detects the first candidate PSS block, the UE may monitor for the first candidate SSS and PBCH block 320-a and the second candidate SSS and PBCH block 320-b within the symbols {7, 8, 9, 10, 11, 12} of the first slot in the first frequency band. As such, the mapping configuration 300-a indicates the location of actually transmitted SSS and PBCH blocks to the UE 115-a, based on which candidate PSS blocks of the set of candidate PSS blocks 315 are detected (e.g., received) by the UE 115-a.

In some cases, the set of candidate PSS blocks 315 and the set of candidate SSS and PBCH blocks may be mapped in consecutive symbols wherein a last symbol of the first set of symbols in which the set of candidate PSS blocks 315 is mapped is consecutive with a first symbol of the second set of symbols in which the first candidate SSS and PBCH block 320-a of the set of candidate SSS and PBCH blocks is mapped. For example, as shown by the mapping configurations 300-a, 300-b, and 300-c, the last symbol of the set of candidate PSS blocks 315 (e.g., symbol 6 of the first slot) is consecutive with the first symbol of the first candidate SSS and PBCH block 320-a (e.g., symbol 7 of the first slot). In some other cases (e.g., not shown), the last symbol of the first set of symbols in which the set of candidate PSS blocks 315 is mapped is non-consecutive with the first symbol of the second set of symbols in which the first candidate SSS and PBCH block 320-a of the set of candidate SSS and PBCH blocks is mapped. In such cases, there is a time offset (e.g., a quantity of symbols) between the last symbol of the set of candidate PSS blocks 315 and the first symbol of the first candidate SSS and PBCH block 320-a.

The mapping configurations 300-a, 300-b, and 300-c are non-limiting examples of mapping configurations enabled by the techniques described herein. For example, each candidate PSS block of the set of candidate PSS blocks 315 may be mapped to a different quantity, combination, or both of SSS and PBCH blocks included in the set of candidate SSS and PBCH blocks. Additionally, each candidate PSS block of the set of candidate PSS blocks 315 may be associated with one or more symbols. As described herein, the frequency domain may be defined in terms of channels, subchannels, bands, subbands, BWPs, or the like (e.g., some SSS and PBCH blocks 320 may be located in a first band, subband, channel, BWP, carrier, CC, or the like, and

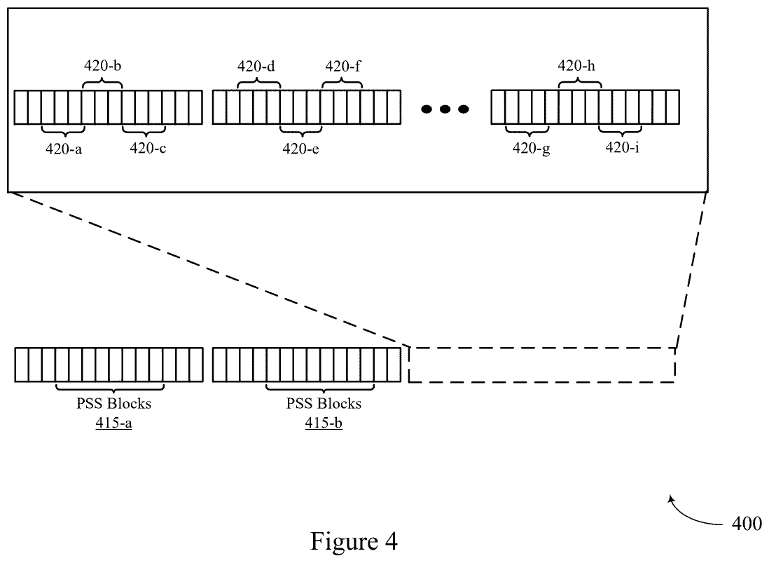

FIG. 4 shows an example of a mapping configuration 400 that supports mapping between PSS blocks and SSS and PBCH blocks for efficient multi-beam operation according to the techniques described herein. In some cases, the mapping configuration 400 may be implemented by or may otherwise implement aspects of the wireless communication system 100, the signaling diagram 200, or the mapping configurations 300-a, 300-b, and 300-c. For example, one or more UEs 115, one or more network entities 105, or both may communicate according to the mapping configuration 400.

In some cases, a set of candidate PSS blocks 415 may be mapped in one or more first symbols and a set SSS and PBCH blocks may be mapped to the set of candidate PSS blocks 415 in one or more second symbols that are included in the same slot as the set of candidate PSS blocks 415, or are included in a separate slot from the set of candidate PSS blocks 415 based on a mapping ratio, K, between the set of candidate PSS blocks 415 and the set of candidate SSS and PBCH blocks. For example, the set of candidate SSS and PBCH blocks may include 48 SSS and PBCH blocks (e.g., SSS/PBCH 0-SSS/PBCH47) which may be mapped to 16 candidate PSS blocks of the set of candidate PSS blocks 415. The set of candidate PSS blocks 415 may include a first subset of candidate PSS blocks 415-a and a second subset of candidate PSS blocks 415-b which may be mapped to 16 symbols within a first slot and a second slot. The set of candidate SSS and PBCH blocks may be mapped in an additional set of slots separate from the first slot and the second slot, based on a quantity of time resources associated with the set of candidate SSS and PBCH blocks exceeding a threshold quantity. As shown by FIG. 4, a first candidate SSS and PBCH block 420-a, a second candidate SSS and PBCH block 420-b, and a third candidate SSS and PBCH block 420-c may be mapped a first slot of the additional set of slots, a fourth candidate SSS and PBCH block 420-d, a fifth candidate SSS and PBCH block 420-e , and a sixth candidate SSS and PBCH block 420-f may be mapped to a second slot of the additional set of slots, and so on, until a third from last candidate SSS and PBCH block 420-g, a second from last candidate SSS and PBCH block 420-h, and a last candidate SSS and PBCH block 420-i are mapped to a last slot of the additional set of slots. In other words, none of the candidate SSS and PBCH blocks 420 of the set of candidate SSS and PBCH blocks share a common slot with the set of candidate PSS blocks 415 based on availability of time resources.

In other cases, the one or more first symbols in which the set of candidate PSS blocks 415 are mapped and the one or more second symbols in which the set of candidate SSS and PBCH blocks are mapped are included in a common slot based at least in part on a quantity of the one or more second symbols satisfying a threshold quantity. Similarly, one or more first symbols in which a candidate PSS block is mapped and one or more second symbols in which a candidate SSS and PBCH block is mapped are included in the common slot (e.g., for a single SSB). Thus, in some examples described herein, one PSS block may span one or more symbols, and the SSS and PBCH blocks may span one or more symbols. For example, if the mapping ratio K is small enough (e.g., K=2) such that the set of candidate PSS blocks 415 and one or more of the candidate SSS and PBCH blocks of the set of candidate SSS and PBCH blocks can be accommodated by the time resources (e.g., quantity of symbols) available in a common slot, the set of candidate PSS blocks 415 and the one or more candidate SSS and PBCH blocks 420 of the set of candidate SSS and PBCH blocks may be mapped in the common slot. As such, based detecting one or more PSS blocks of the set of candidate PSS blocks 215, a UE may search for one or more corresponding SSS and PBCH blocks included in either the common slot or within one or more slots based on the mapping ratio between the one or more PSS blocks and the one or more SSS and PBCH blocks.

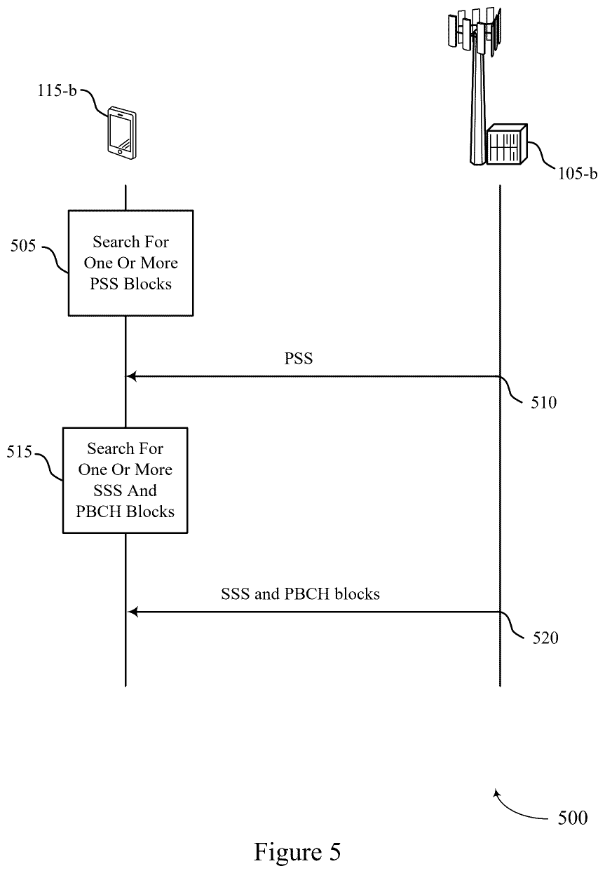

FIG. 5 shows an example of a process flow 500 that supports mapping between PSS blocks and SSS and PBCH blocks for efficient multi-beam operation. The process flow 500 may implement aspects of or may be implemented by aspects of the wireless communication system 100 or the signaling diagram 200, the mapping configurations 300-a, 300-b, and 300-c or the mapping configuration 400. For example, the process flow 500 may include a UE 115-b and a network entity 105-b, which may be examples of the corresponding devices as described herein with reference to FIG. 1.

In the following description of the process flow 500, the operations between the UE 115-b and the network entity 105-b may be communicated in a different order than the example order shown, or the operations performed by the UE 115-b and the network entity 105-b may be performed in different orders or at different times. Some operations may also be omitted from the process flow 500, and other operations may be added to the process flow 500.

At 505, the UE 115-b may search for one or more PSS blocks of a set of candidate PSS blocks, each of which may span one or more first symbols (e.g., of a search window). For example, during a connection establishment and modification procedure, the UE 115-b may search for one or more PSS blocks transmitted by the network entity 105-b. The network entity 105-b may transmit any candidate PSS block included in the set of candidate PSS blocks. Based on the searching, the UE 115-b may detect (e.g., receive at 510) the one or more PSS blocks of the set of candidate PSS blocks.

At 515, the UE 115-b may search for one or more SSS and PBCH blocks of a set of candidate SSS and PBCH blocks based on a mapping (e.g., such as the mapping described with reference to FIG. 2, FIGS. 3A-3C and FIG. 4) between the one or more PSS blocks and the one or more SSS and PBCH blocks. For example, each candidate PSS block of the set of candidate PSS blocks is mapped to one or more candidate SSS and PBCH blocks of the set of candidate SSS and PBCH blocks. In some cases, the mapping between the set of candidate PSS blocks and the set of candidate SSS and PBCH blocks indicates that each candidate PSS block of the set of candidate PSS blocks is mapped to one or more non-consecutive candidate SSS and PBCH blocks according to a pattern, where the pattern maps a first subset of candidate SSS and PBCH blocks to each respective candidate PSS block of the set of candidate PSS blocks and then maps a second subset of candidate SSS and PBCH blocks to each respective candidate PSS block of the set of candidate PSS blocks. In some cases the mapping between the set of candidate PSS blocks and the set of candidate SSS and PBCH blocks indicates that one or more index values corresponding to one or more candidate SSS and PBCH blocks of the set of candidate SSS and PBCH blocks are incremented in ascending order in a first domain, then incremented in ascending order in a second domain (e.g., as described with reference to FIGS. 3A-3C).

At 520, the UE 115-b may receive the one or more SSS and PBCH blocks based on searching for the one or more PSS blocks and the one or more SSS and PBCH blocks, where each of the one or more SSS and PBCH blocks may span one or more second symbols (e.g., of the search window). For example, in some cases, the set of candidate PSS blocks correspond to a first set of symbols and the set of candidate SSS and PBCH blocks correspond to a second set of symbols, where a last symbol of the first set of symbols is consecutive with a first symbol of the second set of symbols. In some other cases, the second set of symbols are offset from the first set of symbols by a time offset. Additionally, the one or more PSS blocks are received in one or more first symbols and the one or more SSS and PBCH blocks are received in one or more second symbols, where the one or more first symbols and the one or more second symbols are included in a common slot based at least in part on a quantity of the one or more second symbols satisfying a threshold quantity. As such, based on the mapping between the set of candidate PSS blocks and the set of candidate SSS and PBCH blocks, the UE 115-b may determine (e.g., detect) which SSS and PBCH blocks of the set of candidate SSS and PBCH blocks are actually transmitted.

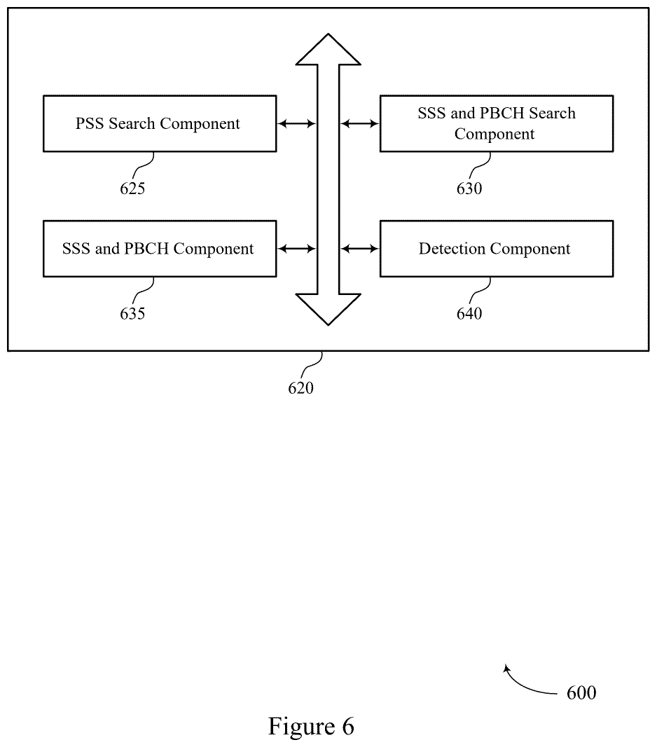

FIG. 6 shows an example 600 of a processing system 620 that supports mapping between PSS blocks and SSS and PBCH blocks for efficient multi-beam operation. A processing system 620 may be an example of a processing system 140 (such as of a UE 115) and may include an PSS search component 625, an SSS and PBCH search component 630, an SSS and PBCH component 635, a detection component 640, or any combination thereof. A processing system 620, or various component thereof, may be an example of means for performing (such as a means for causing a UE 115 to perform) various techniques described herein.

The PSS search component 625 may be configured to cause the UE 115 to search for one or more PSS blocks of a set of candidate PSS blocks. The SSS and PBCH search component 630 may be configured to cause the UE 115 to search for one or more SSS and physical broadcast channel (PBCH) blocks of a set of candidate SSS and PBCH blocks based on a mapping between the one or more PSS blocks and the one or more SSS and PBCH blocks. The SSS and PBCH component 635 may be configured to cause the UE 115 to receive the one or more SSS and PBCH blocks based on searching for the one or more PSS blocks and the one or SSS and PBCH blocks.

In some examples, the detection component 640 may be configured to cause the UE 115 to detect a location of the one or more SSS and PBCH blocks based on receiving the one or more PSS blocks and the mapping indicating an association between the one or more PSS blocks and the one or more SSS and PBCH blocks, where the searching for the one or more SSS and PBCH blocks is based on the detecting.

In some examples, each candidate PSS block of the set of candidate PSS blocks is mapped to one or more candidate SSS and PBCH blocks of the set of candidate SSS and PBCH blocks.

In some examples, the mapping between the set of candidate PSS blocks and the set of candidate SSS and PBCH blocks indicates that each candidate PSS block of the set of candidate PSS blocks is mapped to one or more consecutive candidate SSS and PBCH blocks.

In some examples, the mapping between the set of candidate PSS blocks and the set of candidate SSS and PBCH blocks indicates that each candidate PSS block of the set of candidate PSS blocks is mapped to one or more non-consecutive candidate SSS and PBCH blocks according to a pattern. In some examples, the pattern maps a first subset of candidate SSS and PBCH blocks to each respective candidate PSS block of the set of candidate PSS blocks and then maps a second subset of candidate SSS and PBCH blocks to each respective candidate PSS block of the set of candidate PSS blocks.

In some examples, the mapping between the set of candidate PSS blocks and the set of candidate SSS and PBCH blocks indicates that one or more index values corresponding to one or more candidate SSS and PBCH blocks of the set of candidate SSS and PBCH blocks are incremented in ascending order in a first domain, then incremented in ascending order in a second domain.

In some examples, the first domain is a frequency domain and the second domain is a time domain.

In some examples, the first domain is a time domain and the second domain is a frequency domain.

In some examples, the mapping between the set of candidate PSS blocks and the candidate SSS and PBCH blocks indicates that one or more index values corresponding to one or more candidate SSS and PBCH blocks of the set of candidate SSS and PBCH blocks are incremented in ascending order in a time domain, then incremented in ascending order in a frequency domain.

In some examples, the set of candidate PSS blocks corresponds to a first set of symbols and the set of candidate SSS and PBCH blocks corresponds to a second set of symbols, where each candidate PSS block of the set of candidate PSS blocks spans one or more first symbols within the first set of symbols, and where each candidate SSS and PBCH block of the set of candidate SSS and PBCH blocks spans one or more second symbols within the second set of symbols. In some examples, a last symbol of the first set of symbols is consecutive with a first symbol of the second set of symbols.

In some examples, the set of candidate PSS blocks correspond to a first set of symbols and the set of candidate SSS and PBCH blocks correspond to a second set of symbols, where each candidate PSS block of the set of candidate PSS blocks spans one or more first symbols within the first set of symbols, and wherein each candidate SSS and PBCH block of the set of candidate SSS and PBCH blocks spans one or more second symbols within the second set of symbols. In some examples, the second set of symbols are offset from the first set of symbols by a time offset.

In some examples, the one or more PSS blocks are received in one or more first symbols and the one or more SSS and PBCH blocks are received in one or more second symbols, where the one or more first symbols and the one or more second symbols are included in a common slot based at least in part on a quantity of the one or more second symbols satisfying a threshold quantity.

In some examples, each PSS block of the set of candidate PSS blocks is associated with a first duration of one or more symbols. In some examples, each SSS and PBCH block of the set of candidate SSS and PBCH blocks is associated with a second duration of one or more symbols.

A processing system 620 may include or be a component of one or more chips, systems-on-chips (SoCs), chipsets, packages, components, or devices that individually or collectively constitute or include a processing system. A processing system 620 may interface with other components of a processing system 620. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a processing system 620).

By including or configuring a processing system 620 for operation in a processing system 620 as described herein, the processing system 620 may support techniques for mapping between PSS and SSS and PBCH blocks for efficient multi-beam operation for increased network energy saving and reduced signaling overhead.

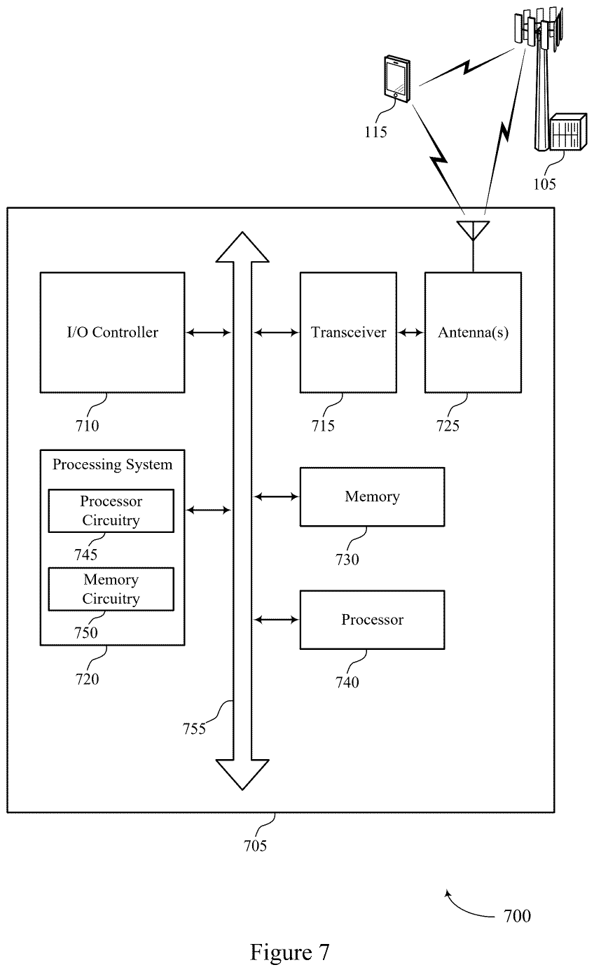

FIG. 7 shows an example of a system 700 including a device 705 that supports mapping between PSS blocks and SSS and PBCH blocks for efficient multi-beam operation. The device 705 may be an example of or include components of UE 115. The device 705 may communicate (such as wirelessly) with one or more other devices (such as network entities 105, UEs 115). The device 705 may include components for transmitting and receiving communication, which may include a processing system 720, an input/output (I/O) controller, such as an I/O controller 710, a transceiver 715, antenna(s) 725, a memory 730, and a processor 740. Components of the device 705 may be coupled (such as operatively, communicatively, functionally, electronically, electrically, in electronic communication) a bus 755.

The transceiver 715 may support bi-directional communication via antenna(s) 725, and may support transmission operations, reception operations, or both, as described herein. The transceiver 715 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 705). The transceiver 715 may modulate symbols and provide the modulated symbols to antenna(s) 725 for transmission, and demodulate symbols from signals received using antenna(s) 725.

The processor 740 may be a general-purpose processing component that supports various operations (such as applications) of the device 705. The memory 730 may be a general-purpose storage component that stores code executable by the processor 740. Such code may include instructions that, when executed by the processor 740, cause the device 705 to perform various functions (such as to support an application of the device 705). The I/O controller 710 may manage inputs and outputs for the device 705, may manage peripherals not integrated into the device 705, or may represent a physical connection (such as port) to an external peripheral. The processor 740 may interact with a modem, a keyboard, a mouse, a touchscreen, or other device (such as via I/O controller 710). In some implementations, a user may interact with the device 705 via the I/O controller 710 or via hardware components controlled by the I/O controller 710.

The processing system 720 may be an example of a processing system 140 or a processing system 620. For example, the processing system 720 may include processor circuitry 745 and memory circuitry 750 that stores code, and may be configured to cause the device 705 to perform operations that support mapping between PSS blocks and SSS and PBCH blocks for efficient multi-beam operation. Although the processing system 720 is illustrated as a separate component, which may involve a separate chip, chipset, or other module, in some implementations, one or more functions described with reference to the processing system 720 may be supported by or performed by a transceiver 715, antenna(s) 725, a processor 740, memory 730, or any combination thereof, such that a processing system 720 may include one or more of a transceiver 715, antenna(s) 725, a processor 740, memory 730, or any combination thereof.

By including or configuring the processing system 720 for operation in the device 705 as described herein, may support techniques for mapping between PSS and SSS and PBCH blocks for efficient multi-beam operation for increased network energy saving and reduced signaling overhead.

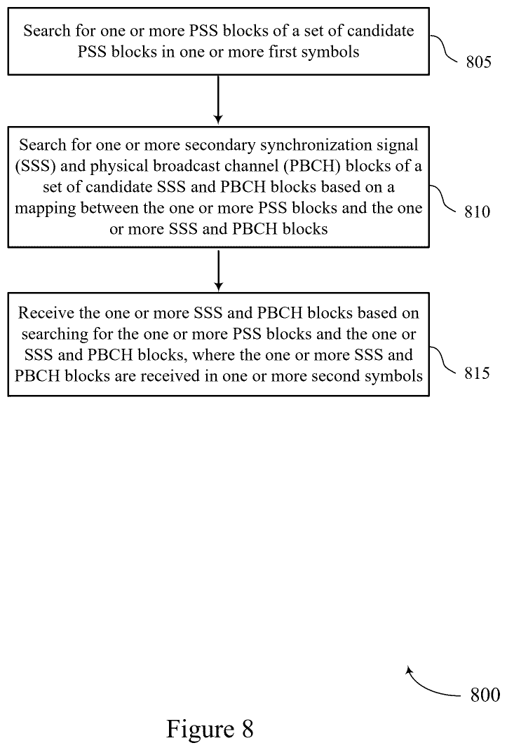

FIG. 8 shows an example of a method 800 that supports mapping between PSS blocks and SSS and PBCH blocks for efficient multi-beam operation. Operations of the method 800 may be performed by a UE or its components (such as using a processing system configured to cause the UE 115 to perform one or more of the operations) as described herein.

At 805, the method may include searching for one or more PSS blocks of a set of candidate PSS blocks. In some examples, aspects of the operations of 805 may be performed by an PSS search component 625.

At 810, the method may include searching for one or more SSS and physical broadcast channel (PBCH) blocks of a set of candidate SSS and PBCH blocks based on a mapping between the one or more PSS blocks and the one or more SSS and PBCH blocks. In some examples, aspects of the operations of 810 may be performed by an SSS and PBCH search component 630.

At 815, the method may include receiving the one or more SSS and PBCH blocks based on searching for the one or more PSS blocks and the one or SSS and PBCH blocks. In some examples, aspects of the operations of 815 may be performed by an SSS and PBCH component 635.

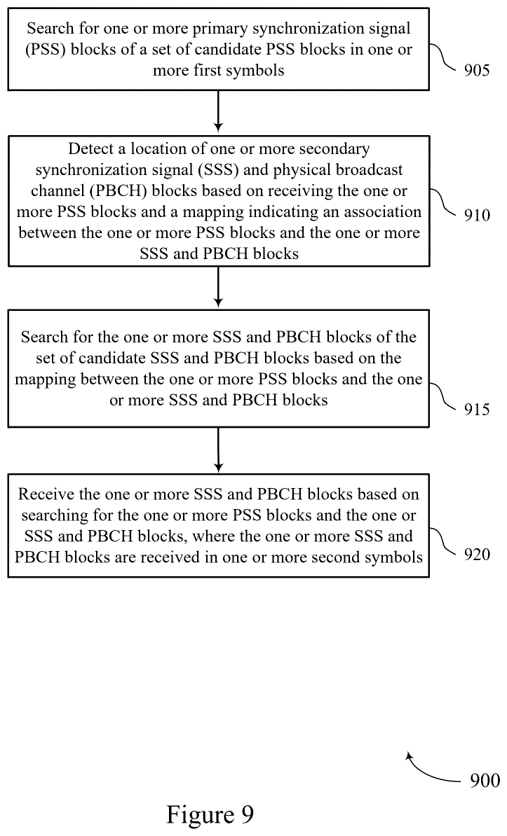

FIG. 9 shows an example of a method 900 that supports mapping between PSS blocks and SSS and PBCH blocks for efficient multi-beam operation. Operations of the method 900 may be performed by a UE or its components (such as using a processing system configured to cause the UE 115 to perform one or more of the operations) as described herein.

At 905, the method may include searching for one or more PSS blocks of a set of candidate PSS blocks. In some examples, aspects of the operations of 905 may be performed by an PSS search component 625.

At 910, the method may include detecting a location of one or more SSS and PBCH blocks based on receiving the one or more PSS blocks and a mapping indicating an association between the one or more PSS blocks and the one or more SSS and PBCH blocks. In some examples, aspects of the operations of 910 may be performed by a detection component 640.

At 915, the method may include searching for one or more SSS and PBCH blocks of a set of candidate SSS and PBCH blocks based on the mapping between the one or more PSS blocks and the one or more SSS and PBCH blocks. In some examples, aspects of the operations of 915 may be performed by an SSS and PBCH search component 630.

At 920, the method may include receiving the one or more SSS and PBCH blocks based on searching for the one or more PSS blocks and the one or SSS and PBCH blocks. In some examples, aspects of the operations of 920 may be performed by an SSS and PBCH component 635.

Implementation examples are described in the following numbered clauses:
Aspect 1: A method for wireless communications at a UE, comprising: searching for one or more PSS blocks of a set of candidate PSS blocks; searching for one or more SSS and physical broadcast channel (PBCH) blocks of a set of candidate SSS and PBCH blocks based at least in part on a mapping between the one or more PSS blocks and the one or more SSS and PBCH blocks; and receiving the one or more SSS and PBCH blocks based at least in part on searching for the one or more PSS blocks and the one or SSS and PBCH blocks.
Aspect 2: The method of aspect 1, further comprising: detecting a location of the one or more SSS and PBCH blocks based at least in part on receiving the one or more PSS blocks and the mapping indicating an association between the one or more PSS blocks and the one or more SSS and PBCH blocks, wherein the searching for the one or more SSS and PBCH blocks is based at least in part on the detecting.
Aspect 3: The method of any of aspects 1 through 2, wherein each candidate PSS block of the set of candidate PSS blocks is mapped to one or more candidate SSS and PBCH blocks of the set of candidate SSS and PBCH blocks.
Aspect 4: The method of any of aspects 1 through 3, wherein the mapping between the set of candidate PSS blocks and the set of candidate SSS and PBCH blocks indicates that each candidate PSS block of the set of candidate PSS blocks is mapped to one or more consecutive candidate SSS and PBCH blocks.
Aspect 5: The method of any of aspects 1 through 3, wherein the mapping between the set of candidate PSS blocks and the set of candidate SSS and PBCH blocks indicates that each candidate PSS block of the set of candidate PSS blocks is mapped to one or more non-consecutive candidate SSS and PBCH blocks according to a pattern, the pattern maps a first subset of candidate SSS and PBCH blocks to each respective candidate PSS block of the set of candidate PSS blocks and then maps a second subset of candidate SSS and PBCH blocks to each respective candidate PSS block of the set of candidate PSS blocks.
Aspect 6: The method of any of aspects 1 through 5, wherein the mapping between the set of candidate PSS blocks and the set of candidate SSS and PBCH blocks indicates that one or more index values corresponding to one or more candidate SSS and PBCH blocks of the set of candidate SSS and PBCH blocks are incremented in ascending order in a first domain, then incremented in ascending order in a second domain.
Aspect 7: The method of aspect 6, wherein the first domain is a frequency domain and the second domain is a time domain.
Aspect 8: The method of aspect 6, wherein the first domain is a time domain and the second domain is a frequency domain.
Aspect 9: The method of any of aspects 1 through 5, wherein the mapping between the set of candidate PSS blocks and the candidate SSS and PBCH blocks indicates that one or more index values corresponding to one or more candidate SSS and PBCH blocks of the set of candidate SSS and PBCH blocks are incremented in ascending order in a time domain, then incremented in ascending order in a frequency domain.
Aspect 10: The method of any of aspects 1 through 9, wherein the set of candidate PSS blocks correspond to a first set of symbols and the set of candidate SSS and PBCH blocks correspond to a second set of symbols, wherein each candidate PSS block of the set of candidate PSS blocks spans one or more first symbols within the first set of symbols, and wherein each candidate SSS and PBCH block of the set of candidate SSS and PBCH blocks span one or more second symbols within the second set of symbols, and wherein a last symbol of the first set of symbols is consecutive with a first symbol of the second set of symbols.
Aspect 11: The method of any of aspects 1 through 9, wherein the set of candidate PSS blocks corresponds to a first set of symbols and the set of candidate SSS and PBCH blocks corresponds to a second set of symbols, wherein each candidate PSS block of the set of candidate PSS blocks spans one or more first symbols within the first set of symbols, and wherein each candidate SSS and PBCH block of the set of candidate SSS and PBCH blocks spans one or more second symbols within the second set of symbols, and wherein the second set of symbols are offset from the first set of symbols by a time offset.
Aspect 12: The method of any of aspects 1 through 11, wherein the one or more PSS blocks are received in one or more first symbols and the one or more SSS and PBCH blocks are received in one or more second symbols, wherein the one or more first symbols and the one or more second symbols are included in a common slot based at least in part on a quantity of the one or more second symbols satisfying a threshold quantity.
Aspect 13: The method of any of aspects 1 through 12, wherein each PSS block of the set of candidate PSS blocks is associated with a first duration of one or more symbols, and each SSS and PBCH block of the set of candidate SSS and PBCH blocks is associated with a second duration of one or more symbols.
Aspect 14: A UE for wireless communications, comprising a processing system that includes processor circuitry and memory circuitry that stores code, the processing system configured to cause the UE to perform a method of any of aspects 1 through 13.
Aspect 15: A UE for wireless communications, comprising at least one means for performing a method of any of aspects 1 through 13.
Aspect 16: A non-transitory computer-readable medium storing code for wireless communications, the code comprising instructions executable by one or more processors to perform a method of any of aspects 1 through 13.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
search for one or more primary synchronization signal (PSS) blocks of a set of candidate PSS blocks;
search for one or more secondary synchronization signal (SSS) and physical broadcast channel (PBCH) blocks of a set of candidate SSS and PBCH blocks based at least in part on a mapping between the one or more PSS blocks and the one or more SSS and PBCH blocks; and
receive the one or more SSS and PBCH blocks based at least in part on searching for the one or more PSS blocks and the one or SSS and PBCH blocks.

2. The UE of claim 1, wherein the processing system is further configured to cause the UE to:
detect a location of the one or more SSS and PBCH blocks based at least in part on receiving the one or more PSS blocks and the mapping indicating an association between the one or more PSS blocks and the one or more SSS and PBCH blocks, wherein the searching for the one or more SSS and PBCH blocks is based at least in part on the detecting.

3. The UE of claim 1, wherein each candidate PSS block of the set of candidate PSS blocks is mapped to one or more candidate SSS and PBCH blocks of the set of candidate SSS and PBCH blocks.

4. The UE of claim 1, wherein the mapping between the set of candidate PSS blocks and the set of candidate SSS and PBCH blocks indicates that each candidate PSS block of the set of candidate PSS blocks is mapped to one or more consecutive candidate SSS and PBCH blocks.

5. The UE of claim 1, wherein the mapping between the set of candidate PSS blocks and the set of candidate SSS and PBCH blocks indicates that each candidate PSS block of the set of candidate PSS blocks is mapped to one or more non-consecutive candidate SSS and PBCH blocks according to a pattern, wherein the pattern maps a first subset of candidate SSS and PBCH blocks to each respective candidate PSS block of the set of candidate PSS blocks and then maps a second subset of candidate SSS and PBCH blocks to each respective candidate PSS block of the set of candidate PSS blocks.

6. The UE of claim 1, wherein the mapping between the set of candidate PSS blocks and the set of candidate SSS and PBCH blocks indicates that one or more index values corresponding to one or more candidate SSS and PBCH blocks of the set of candidate SSS and PBCH blocks are incremented in ascending order in a first domain, then incremented in ascending order in a second domain.

7. The UE of claim 6, wherein the first domain is a frequency domain and the second domain is a time domain.

8. The UE of claim 6, wherein the first domain is a time domain and the second domain is a frequency domain.

9. The UE of claim 1, wherein the mapping between the set of candidate PSS blocks and the candidate SSS and PBCH blocks indicates that one or more index values corresponding to one or more candidate SSS and PBCH blocks of the set of candidate SSS and PBCH blocks are incremented in ascending order in a time domain, then incremented in ascending order in a frequency domain.

10. The UE of claim 1, wherein the set of candidate PSS blocks corresponds to a first set of symbols and the set of candidate SSS and PBCH blocks corresponds to a second set of symbols, wherein each candidate PSS block of the set of candidate PSS blocks spans one or more first symbols within the first set of symbols, and wherein each candidate SSS and PBCH block of the set of candidate SSS and PBCH blocks span one or more second symbols within the second set of symbols, and wherein a last symbol of the first set of symbols is consecutive with a first symbol of the second set of symbols.

11. The UE of claim 1, wherein the set of candidate PSS blocks corresponds to a first set of symbols and the set of candidate SSS and PBCH blocks corresponds to a second set of symbols, wherein each candidate PSS block of the set of candidate PSS blocks spans one or more first symbols within the first set of symbols, and wherein each candidate SSS and PBCH block of the set of candidate SSS and PBCH blocks span one or more second symbols within the second set of symbols, and wherein the second set of symbols are offset from the first set of symbols by a time offset.

12. The UE of claim 1, wherein the one or more PSS blocks are received in one or more first symbols and the one or more SSS and PBCH blocks are received in one or more second symbols, wherein the one or more first symbols and the one or more second symbols are included in a common slot based at least in part on a quantity of the one or more second symbols satisfying a threshold quantity.

13. The UE of claim 1, wherein each PSS block of the set of candidate PSS blocks is associated with a first duration of one or more symbols, and wherein each SSS and PBCH block of the set of candidate SSS and PBCH blocks is associated with a second duration of one or more symbols.

14. A method for wireless communications at a user equipment (UE), comprising:
searching for one or more PSS blocks of a set of candidate PSS blocks;
searching for one or more SSS and PBCH blocks of a set of candidate SSS and PBCH blocks based at least in part on a mapping between the one or more PSS blocks and the one or more SSS and PBCH blocks; and
receiving the one or more SSS and PBCH blocks based at least in part on searching for the one or more PSS blocks and the one or SSS and PBCH blocks.

15. The method of claim 14, further comprising:
detecting a location of the one or more SSS and PBCH blocks based at least in part on receiving the one or more PSS blocks and the mapping indicating an association between the one or more PSS blocks and the one or more SSS and PBCH blocks, wherein the searching for the one or more SSS and PBCH blocks is based at least in part on the detecting.

16. The method of claim 14, wherein each candidate PSS block of the set of candidate PSS blocks is mapped to one or more candidate SSS and PBCH blocks of the set of candidate SSS and PBCH blocks.

17. The method of claim 14, wherein the mapping between the set of candidate PSS blocks and the set of candidate SSS and PBCH blocks indicates that each candidate PSS block of the set of candidate PSS blocks is mapped to one or more consecutive candidate SSS and PBCH blocks.

18. The method of claim 14, wherein the mapping between the set of candidate PSS blocks and the set of candidate SSS and PBCH blocks indicates that each candidate PSS block of the set of candidate PSS blocks is mapped to one or more non-consecutive candidate SSS and PBCH blocks according to a pattern, and wherein the pattern maps a first subset of candidate SSS and PBCH blocks to each respective candidate PSS block of the set of candidate PSS blocks and then maps a second subset of candidate SSS and PBCH blocks to each respective candidate PSS block of the set of candidate PSS blocks.

19. The method of claim 14, wherein the mapping between the set of candidate PSS blocks and the set of candidate SSS and PBCH blocks indicates that one or more index values corresponding to one or more candidate SSS and PBCH blocks of the set of candidate SSS and PBCH blocks are incremented in ascending order in a first domain, then incremented in ascending order in a second domain.

20. A user equipment (UE) for wireless communications, comprising:
means for searching for one or more PSS blocks of a set of candidate PSS blocks;
means for searching for one or more SSS and PBCH blocks of a set of candidate SSS and PBCH blocks based at least in part on a mapping between the one or more PSS blocks and the one or more SSS and PBCH blocks; and
means for receiving the one or more SSS and PBCH blocks based at least in part on searching for the one or more PSS blocks and the one or SSS and PBCH blocks.
